(19) United States
(12) Patent Application Publication
(10) Pub. No.: US 2003/0123657 A1
(43) Pub. Date: Jul. 3, 2003

(54) Methods and apparatus for simultaneously decrypting multiple services received on separate multiplexed transport streams

(75) Inventors: David M. Bjordammen, Blue Bell, PA (US); Lawrence D. Vince, Lansdale, PA (US); Glen Peter Goffin II, Fountainville, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/036,562

(22) Filed: Dec. 31, 2001

(51) Int. Cl. H04L 9/00

(52) U.S. Cl. 380/42

(57) ABSTRACT

The present invention relates to methods and apparatus for simultaneously decrypting multiple services received on separate encrypted multiplexed transport streams. A plurality of encrypted multiplexed transport streams may be received at a television terminal. Each transport stream may have at least one service. The plurality of multiplexed transport streams may be received by, for example, multiple tuning devices and/or provided from a storage device, such as a Personal Versatile Recorder (PVR). A plurality of desired services are selected from a subset of the transport streams. The desired services are multiplexed into a desired service multiplex and decrypted by a single decryption engine to provide a desired decrypted multiplex. The desired decrypted multiplex is then demultiplexed so that the desired services can be decoded and provided to a user.

### BACKGROUND OF THE INVENTION

The present invention relates generally to the field of electronic communications, such as the communication of television, multimedia, and/or interactive entertainment and information signals. More specifically, the present invention relates to methods and apparatus for providing simultaneous decryption of multiple services (e.g., television channels) received on separate multiplexed transport streams.

As the number and type of television and other multimedia services made available to a consumer rapidly increases, methods for enabling a television terminal or similar appliance to receive, process, and display the large number and differing types of services are required. For example, a television terminal may be adapted to receive television programming via cable or satellite, either through a monthly subscription or on-demand pay-per-view. In addition, certain television terminals exist and/or are being developed which are capable of providing additional services, which may include email, web browsing, Internet services, streaming media, electronic programming guides, advertising, audio-on-demand, telephony services, stock prices, weather data, travel services and information, games, gambling, banking, shopping, interactive television, and the like. Further, certain television terminals provide personal versatile recording functions, such as the personal versatile recorder (PVR) system developed by General Instrument Corporation of Horsham, Pa., the assignee of the present invention. One implementation of a PVR is described in commonly owned U.S. patent application Ser. No. 09/520,968, filed on Mar. 8, 2000, entitled “Personal Versatile Recorder and Method of Implementing and Using Same.”

In an effort to accommodate the various services available to a consumer from various sources via the television terminal, it would be advantageous to provide two or more separate tuners in the television terminal for receipt of separate multiplexed transport streams which contain such services. Separate tuners not only enable the receipt of various types of services by the terminal as discussed above, but also enable the various services to be provided together with such functionality such as picture-in-picture, enhanced or interactive television, watching one program while recording a second program at the PVR or similar device, watching a program from the PVR and recording a second program at the PVR, and the like. However, the cost of such a terminal will be increased, not only due to the inclusion of the additional tuners, but also due to the inclusion of the additional decryption device needed for each additional tuner. Such additional decryption devices will also increase the complexity of the required access control for the services at the terminal.

Therefore, it would be advantageous to provide methods and apparatus for simultaneously decrypting multiple services received on separate multiplexed transport streams using a single decryption device. It would be further advantageous to provide for decryption of multiple services received on separate transport streams without impacting the security features (“access control”) provided by the terminal.

The methods and apparatus of the present invention provide the foregoing and other advantages.

### SUMMARY OF THE INVENTION

The present invention relates to methods and apparatus for simultaneously decrypting multiple services received on separate encrypted multiplexed transport streams. A plurality of encrypted multiplexed transport streams may be received at a television terminal. Each transport stream may have at least one service. The plurality of multiplexed transport streams may be received by, for example, multiple tuning devices and/or provided from a storage device, such as a PVR. A plurality of desired services are selected from a subset of the transport streams. The desired services are multiplexed into a desired service multiplex and decrypted by a single decryption engine to provide a desired decrypted multiplex. The desired decrypted multiplex is then demultiplexed so that the desired services can be decoded and provided to a user.

### BRIEF DESCRIPTION OF THE DRAWINGS

The present invention will hereinafter be described in conjunction with the appended drawing figures, wherein like numerals denote like elements, and:

FIG. 1 is a block diagram of an exemplary embodiment of the invention;

FIG. 2 is a block diagram of a second example embodiment of the invention;

FIG. 3 is a block diagram of an access control processor used in connection with the present invention;

FIG. 4 is a block diagram of a third example embodiment of the invention;

FIG. 5 is a block diagram of a fourth example embodiment of the invention; and

FIG. 6 shows a block diagram of a fifth example embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

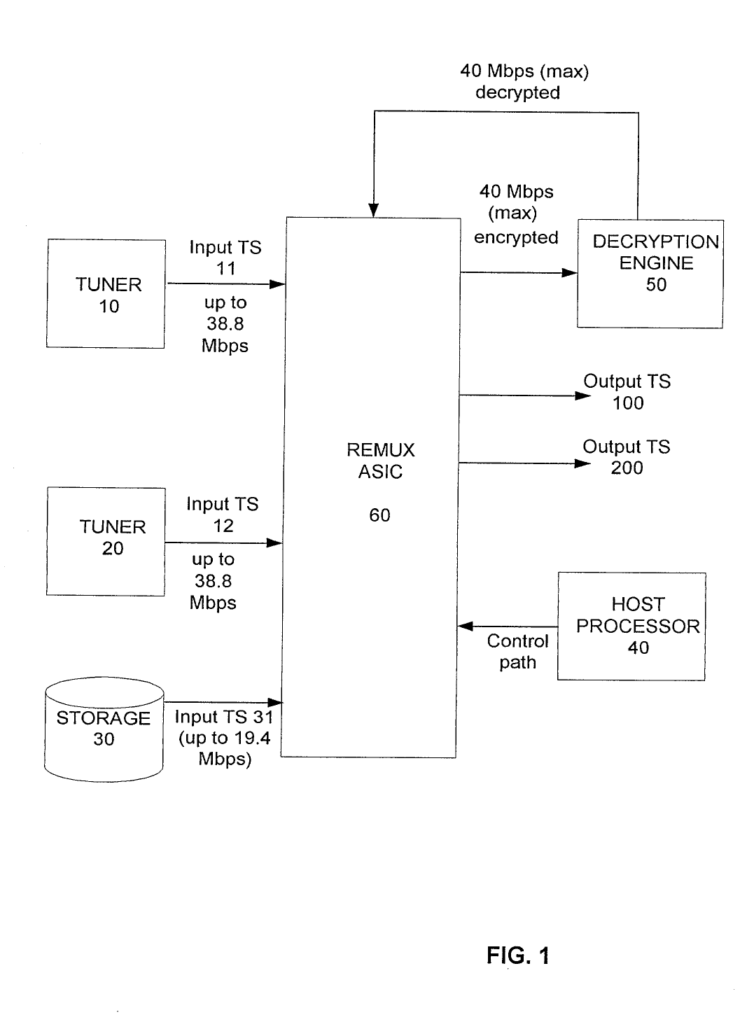

In an exemplary embodiment of the invention as shown in FIG. 1, multiple services are received on separate encrypted multiplexed transport streams at a television terminal. For example, N encrypted multiplexed transport streams may be received at separate tuning devices and/or may be provided from a storage device (e.g., a PVR system) located within or external to the terminal itself. For simplicity and ease of explanation, FIG. 1 shows three transport streams (i.e. N equals three), one transport stream TS 11 provided by tuner 10, a second transport stream TS 12 provided by tuner 20, and a third transport stream TS 31 provided by storage device 30. Each transport stream may have at least one service. A plurality of desired services are selected from M of said N transport streams. In FIG. 1, M is shown as equal to two (i.e. the desired services are contained within two of the three encrypted multiplexed transport streams). The selection of the desired services may be enabled via a host processor 40. These desired services are multiplexed into a desired service multiplex. A single decryption engine 50 decrypts the desired service multiplex to obtain a desired decrypted multiplex. The desired decrypted multiplex is demultiplexed so that the desired services can be output (e.g., TS 100 and TS 200) and decoded for display and/or stored for later use.

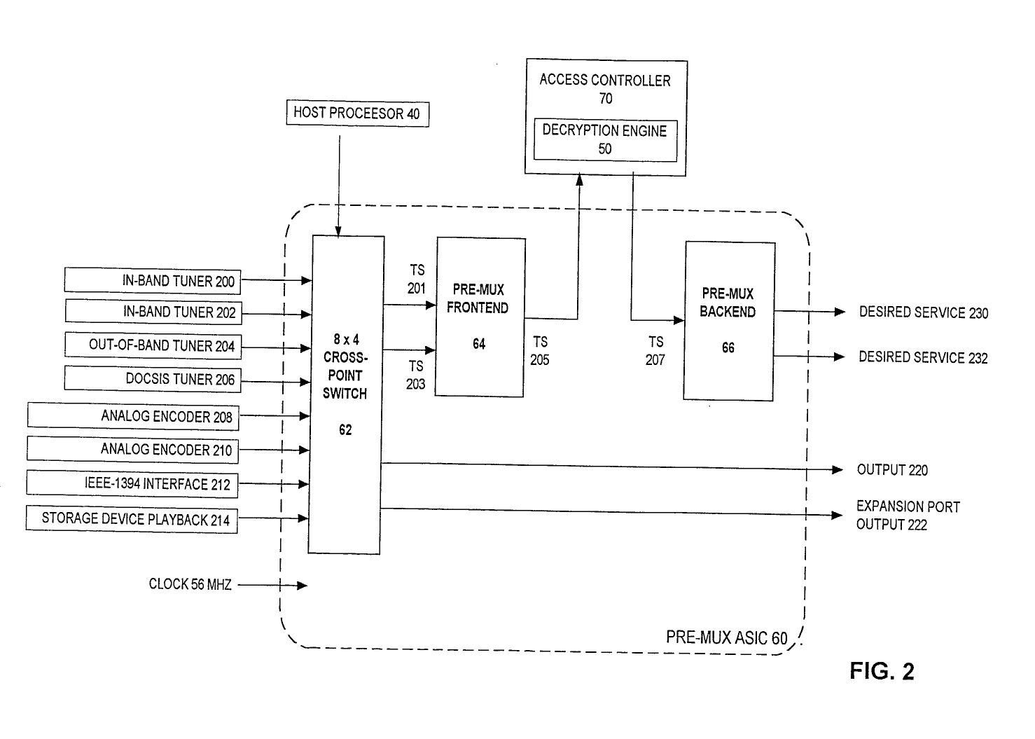

The selection of the desired transport streams may be made by the host processor 40 in cooperation with an Application Specific Integrated Circuit (ASIC) 60, which ASIC 60 also provides for multiplexing the desired services into the desired service multiplex and demultiplexing of the desired decrypted multiplex. Detailed embodiments of the ASIC 60 are discussed in connection with FIGS. 2, and 4 to 6 below. Those skilled in the art will appreciate that, although the invention is described as implemented using an ASIC, the invention may also be implemented using a variety of discrete hardware, firmware, and software components, multiple ASICs, or various combinations thereof.

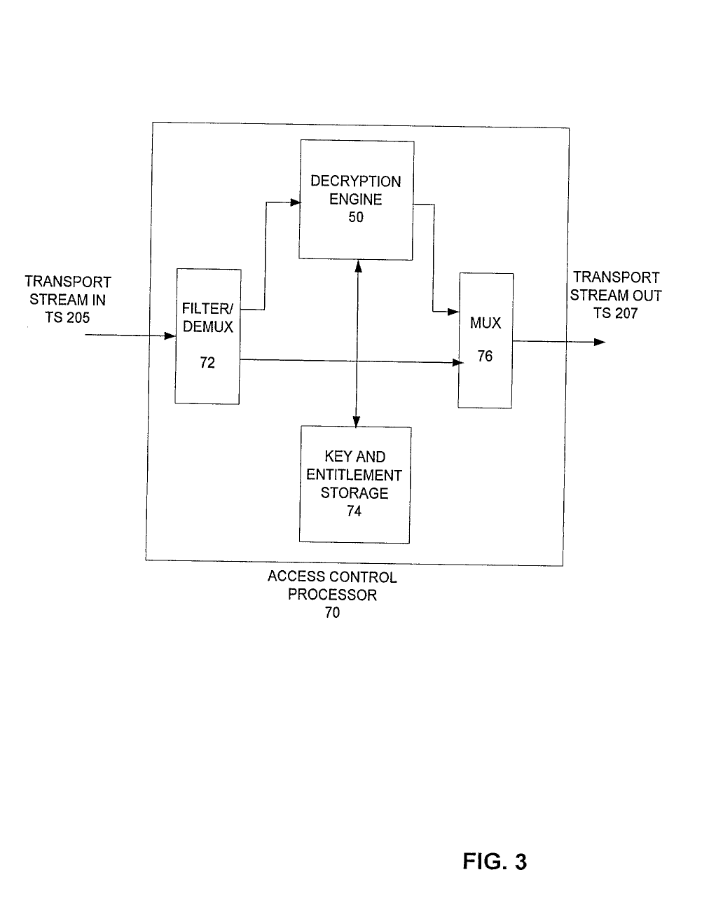

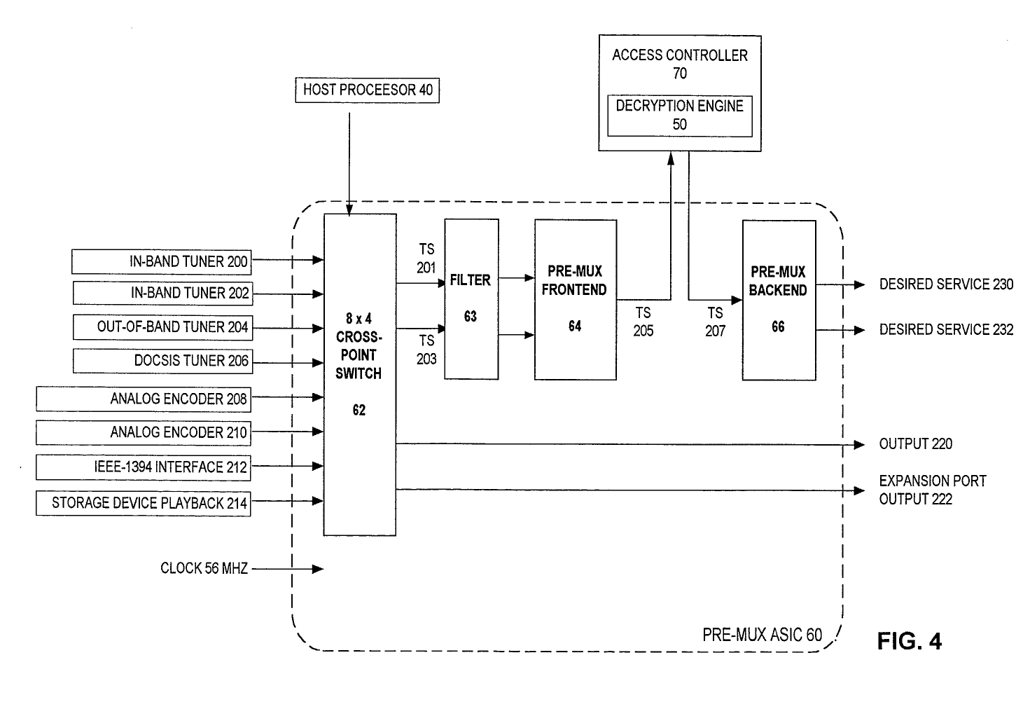

The M transport streams may be demultiplexed or filtered in order to obtain the desired services from each of the multiplexed transport streams. As discussed in more detail below in connection with FIGS. 3 and 4, this demultiplexing or filtering may occur at various points in the inventive process. Therefore, it should be appreciated that the desired service multiplex may also contain additional services, which additional services may be filtered out prior to decryption of the desired services.

At least one of the M transport streams may comprise an MPEG (Moving Picture Experts Group) stream. Alternatively, each of the M transport streams may comprise one of an MPEG stream or an Internet Protocol based stream.

As discussed above, the N encrypted multiplexed transport streams may be provided by a tuning device. The tuning device may comprise at least one in-band tuner, at least one out-of-band tuner, at least one DOCSIS (Data Over Cable Service Interface Specification) tuner, at least one analog encoder, at least one IEEE-1394 network interface, and at least one playback channel from a storage device. Those skilled in the art will appreciate that the storage device 30 may be a part of a variety of devices, such as a PVR, a VCR, a digital video recorder, or the like. The storage device 30 may take many forms, such as a hard drive, an optical disk, or any other suitable type of mass storage device, or combination of devices. Those skilled in the art will appreciate that the tuning device may comprise a single device with multiple tuners or discrete component parts.

FIG. 2 shows a further embodiment of the invention. The M transport streams may be selected from said N transport streams using a cross-point switching device 62 having N inputs and at least M outputs, or any similar type of device. In the example shown in FIG. 2, N equals eight (i.e. eight encrypted multiplexed transport streams are received at the cross-point switching device 62) and M equals two (i.e. two of the eight encrypted multiplexed transport streams which contain desired services are selected for decryption and are output from the cross-point switching device 62). The eight encrypted multiplexed transport streams are provided to ASIC 60 by a tuning device which may comprise a first in-band tuner 200, a second in-band tuner 202, an out-of-band tuner 204, a DOCSIS tuner 206, a first analog encoder 208, a second analog encoder 210, an IEEE-1394 network interface 212, and a playback channel from a storage device 214. In the example shown in FIG. 2, the cross point switch is shown as an 8×4 cross point switch 62. The 8×4 cross point switch 62 shown in FIG. 2 enables the selection of the two multiplexes TS 201 and TS 203 which contain the desired services from the eight encrypted multiplexed transport streams provided to the switch 62.

The 8×4 cross point switch 62 of FIG. 2 also provides two outputs which are passed straight through the ASIC 60 without being processed for decryption. A first output 220 may consist of an unencrypted service which can be passed through for display or storage on the hard drive. The second output 222 shown in FIG. 2 is shown as an expansion port outlet, to provide for future capabilities where decryption is not necessary.

In FIG. 2, the host processor 40 enables the selection of two encrypted multiplexed transport streams TS 201 and TS 203 having the two desired services. The two encrypted multiplexed transport streams TS 201 and TS 203 are output from the cross-point switch 62 to a pre-multiplexer (pre-mux) front end 64. The pre-mux front end 64 prepares the two transport streams TS 201 and TS 203 to be multiplexed together to provide the desired service multiplex. The preparation for multiplexing may include, for example, resolving conflicts in protocol data between the two transport streams and performing rate conversions in order to enable two arbitrary streams with independent and indeterminate time bases to be multiplexed together without loss of packets due to buffer overrun or underrun. Rate conversions may be enabled by use of gapped clocks or the insertion of null packets when multiplexing the two transport streams TS 201 and TS 203. The pre-mux front end 64 then multiplexes the two transport streams TS 201 and TS 203 together to create a desired service multiplex transport stream TS 205 containing the desired services, which is provided to the decryption engine 50.

In FIG. 2, the decryption engine is shown as part of the access controller 70. Those skilled in the art will appreciate that the decryption engine 50 can also be a separate device associated with the access controller 70.

The access controller 70 provides conditional access to the desired services as is well known in the art. See, for example, U.S. Pat. No. 4,613,901 to Gilhousen, et al., entitled “Signal Encryption and Distribution System for Controlling Scrambling and Selective Remote Descrambling of Television Signals,” incorporated herein by reference. In the Gilhousen, et al. system, various cryptographic keys are provided for use in providing an encrypted television signal, which authorized subscribers can decrypt at a decoder. The present invention enables the use of a single access controller where the desired services are received on separate encrypted multiplexed transport streams via different tuners. Advantageously, the single controller 70 used for the various streams can be a standard access controller, which does not have to be modified in order to implement the invention. Without the ASIC 60 of the present invention shown in FIG. 2, separate decryption devices would be needed for each of the N input encrypted multiplexed transport streams, and access control over the services carried on these independent streams would become increasingly complicated as the number of input streams (and the corresponding number of decryption engines) increased.

The decryption engine 50 decrypts the desired service multiplex TS 205 to provide the desired decrypted multiplex transport stream TS 207. The desired decrypted multiplex TS 207 is forwarded to pre-multiplexer (pre-mux) backend 66, which demultiplexes the transport stream to provide the desired services 230 and 232 as output. The desired services 230, 232 may then be further processed for display and/or storage. Original protocol data may also be restored to each service at the pre-mux backend 66, if necessary.

FIG. 3 is a block diagram of an example embodiment of the access controller 70. The desired service multiplex transport stream TS 205 containing the desired services is received by the access controller 70 from the ASIC 60. As the desired service multiplex transport stream TS 205 may include services in addition to the desired services, an optional filter/demultiplexer 72 may be provided to separate the desired services to be decrypted from the remaining services. Further, filter/demultiplexer 72 may be used to separate authorized services from unauthorized services at access controller 70. The desired services are then sent to the decryption engine 50, which decrypts the desired services in connection with a key and entitlement storage device 74, which provides the decryption engine 50 with decryption keys in accordance with the terminal's entitlement to the requested services in a known manner. At multiplexer 76, the decrypted services are multiplexed together with any unauthorized or unselected services, which are passed through from filter/demultiplexer 72 without decryption. The desired decrypted multiplex transport stream TS 207 containing the decrypted desired services is provided from the access controller to the pre-mux backend 66 of ASIC 60 as discussed in connection with FIG. 2 above.

As discussed above, one of the M transport streams may be provided by a playback channel from a storage device, e.g., storage device playback 214. The decryption engine 50 may also be used to encrypt. For example, the decryption engine 50 may be used to encrypt MPEG encoded analog transport streams, which may be stored on the storage device 214 for later decryption as discussed above. Access to the services on the storage device 214 may be provided on an on-demand basis for a fee via access controller 70. For example, the present invention enables pay-per-view programming to be encrypted by the decryption engine 50 and routed to the storage device 214. Once authorization for the purchase is completed, the access controller 70 can allow the desired programming to be decrypted and viewed from storage device 214.

In an alternate embodiment of the invention as shown in FIG. 4, the transport streams TS 201 and TS 203 containing the desired services may be filtered at filter 63 to remove any services from each encrypted multiplexed transport stream which were not selected. In this embodiment, only the selected services on transport streams TS 201 and TS 203 are passed on to the pre-mux front end 64. As discussed above in connection with FIG. 3, this filtering may optionally take place at the access controller 70. Further, those skilled in the art will appreciate that this filtering may also occur prior to the cross-point switch 62.

The selection of the desired services is enabled via a host processor 40. The host processor 40 communicates with the re-mux ASIC 60 to enable selection of the desired services. For example, the host processor 40 may enable the cross-point switch 62 to select and output the encrypted multiplexed transport streams having the desired services which are to be decrypted.

The services may comprise television services. The services may also comprise various other services, including but not limited to email, web browsing, Internet services, streaming media, electronic programming guides, advertising, audio-on-demand, telephony services, stock prices, weather data, travel services and information, games, gambling, banking, shopping, interactive television, and the like.

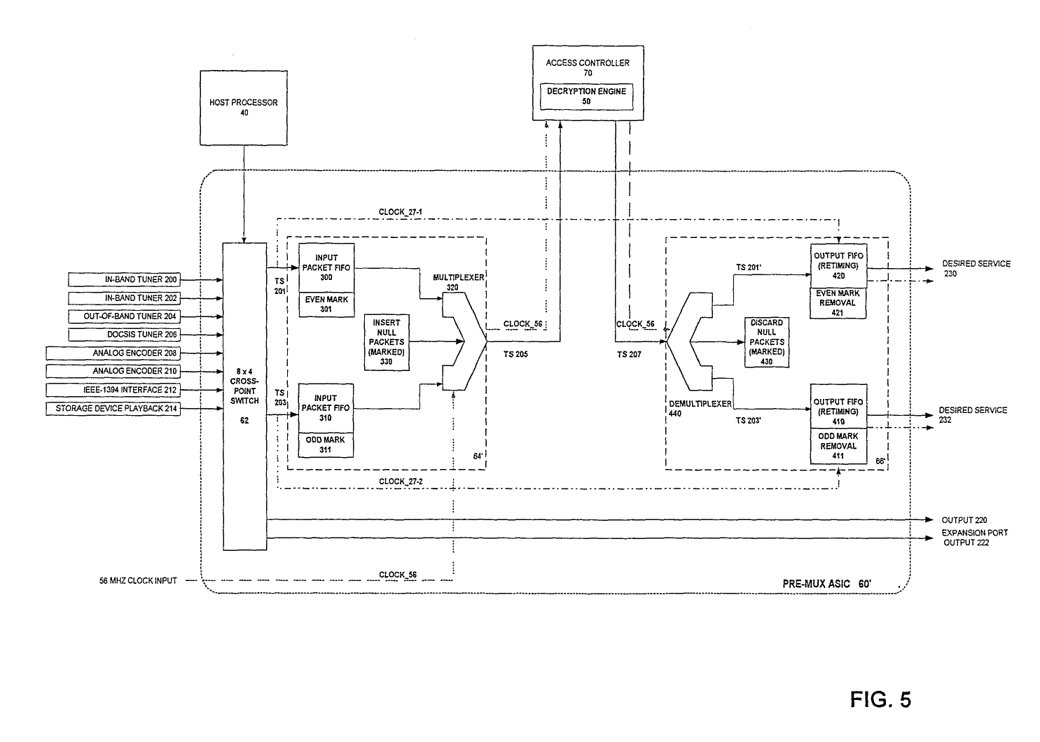

In a further embodiment of the invention, conflicts in protocol data may be resolved among the selected services in the desired service multiplex. Resolution of conflict in protocol data may be necessary to avoid conflicts when the desired services from separate transport streams are combined. The original protocol data may be restored to the selected services when demultiplexing the desired decrypted multiplex. Resolving the conflicts in the protocol data may comprise re-mapping program identifiers. Alternately, resolving conflicts in the protocol data may comprise utilizing transport priority bits from the packet headers of the M transport streams to distinguish between the services selected from the M transport streams. FIG. 5 shows an exemplary embodiment of the invention where conflicts in protocol data are resolved using transport priority bits from the packet headers of the encrypted multiplexed transport streams carrying the desired services. The encrypted multiplexed transport stream containing the selected services TS 201 and TS 203 are forwarded to respective fist-in first-out buffers (input packet FIFO 300 and input packet FIFO 310) in the pre-mux front end 64′ of the pre-mux ASIC 60′. At FIFO 300 the transport priority bit of the incoming transport stream TS 201 is set with an even mark 301. At FIFO 310 the transport priority bit of the incoming transport stream TS 203 is set with an odd mark 311. The two transport streams TS 201 and TS 203 are then sent to multiplexer 320 in the pre-mux front end 64′. The pre-mux front end 64′ may also include a null packet insertion device 330 to provide rate compensation between the two transport streams TS 201 and TS 203 if necessary.

The desired service multiplex transport stream TS 205 from the pre-mux front end 64′ is then forwarded to the access controller 70 and decryption engine 50 for processing as discussed above. The desired decrypted service multiplex transport stream TS 207 containing the desired decrypted services is then provided from the access controller to the pre-mux back end 66′, where the desired decrypted multiplex transport stream TS 207 is demultiplexed at demultiplexer 440. Null packets, if inserted at the pre-mux front end 64′, are discarded by a null packet removal device 430. Each demultiplexed decrypted transport stream TS 201′ and TS 203′ is sent to a respective output FIFO (output FIFO 420 and output FIFO 410), where the even and odd marks are removed from the transport priority bits of the respective transport streams (421 and 411, respectively). The demultiplexed, decrypted desired services are then output from the ASIC 60′ for further processing as discussed above.

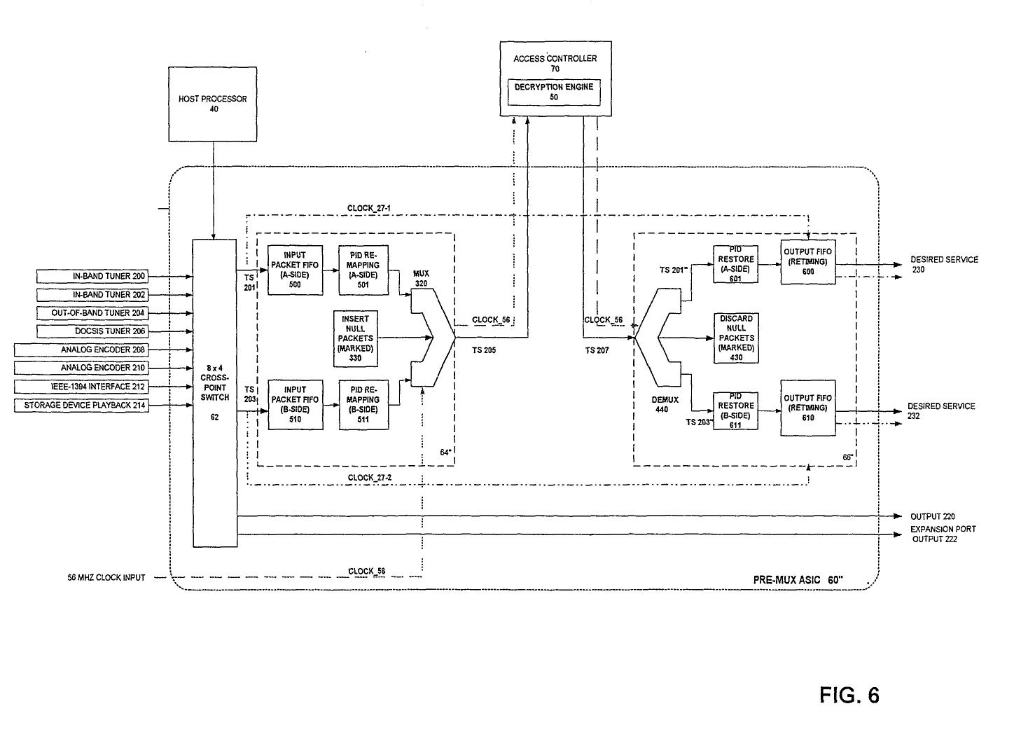

FIG. 6 shows an exemplary embodiment of the invention where conflicts in protocol data are resolved by re-mapping program identifiers (PIDs). The encrypted multiplexed transport stream containing the selected services TS 201 and TS 203 are forwarded to respective fist-in first-out buffers (input packet FIFO 500 and input packet FIFO 510) in the pre-mux front end 64″ of the pre-mux ASIC 60″. The output of FIFO 500 and FIFO 510 is provided to PID re-mapping device 501 and 511, respectively, for re-mapping of the PIDs of each transport stream. The two transport streams TS 201 and TS 203 are then sent to multiplexer 320 in the pre-mux front end 64′. The pre-mux front end 64′ may also include a null packet insertion device 330 to provide rate compensation between the two transport streams TS 201 and TS 203 if necessary.

The desired service multiplex transport stream TS 205 from the pre-mux front end 64′ is then forwarded to the access controller 70 and decryption engine 50 for processing as discussed above. The desired decrypted multiplex transport stream TS 207 containing the desired decrypted services is then provided from the access controller 70 to the pre-mux back end 66″, where the desired decrypted multiplex transport stream TS 207 is demultiplexed at demultiplexer 440. Null packets, if inserted at the pre-mux front end 64′, are discarded by a null packet removal device 430. Original PIDs are restored to each transport stream TS 201″ and TS 203″ at PID restore device 601 and 611 respectively. Each demultiplexed decrypted transport stream is then sent to a respective output FIFO (output FIFO 600 and output FIFO 610). The demultiplexed, decrypted desired services are then output from the ASIC 60″ for further processing as discussed above.

A detailed discussion of the resolution of conflicts in protocol data can be found in commonly owned U.S. patent application Ser. No. 09/591,974, entitled “Apparatus and Methods for Resolution of Conflicts in Protocol Data of Multiple Data Streams,” filed on Jun. 12, 2000.

It should now be appreciated that the present invention provides advantageous methods and apparatus for decrypting multiple services received on separate encrypted multiplexed transport streams, without the need for separate decryption engines for each type of transport stream received and without impacting the access control of the television terminal.

Although the invention has been described in connection with various illustrated embodiments, numerous modifications and adaptations may be made thereto without departing from the spirit and scope of the invention as set forth in the claims.

What is claimed is:

1. A method for simultaneously decrypting multiple services received on separate encrypted multiplexed transport streams, comprising the steps of:
receiving N encrypted multiplexed transport streams, each transport stream having at least one service;
selecting a plurality of desired services from M of said N transport streams;
multiplexing said desired services into a desired service multiplex;
decrypting the desired service multiplex to obtain a desired decrypted multiplex; and
demultiplexing said desired decrypted multiplex.

2. A method in accordance with claim 1, further comprising:
at least one of demultiplexing or filtering said M transport streams.

3. A method in accordance with claim 1, wherein at least one of said M transport streams comprises an MPEG stream.

4. A method in accordance with claim 1, wherein:
each of said M transport streams comprises one of an MPEG stream or an Internet Protocol based stream.

5. A method in accordance with claim 1, further comprising:
resolving conflicts in protocol data among the selected services in the desired service multiplex; and
restoring original protocol data to the selected services when demultiplexing the desired decrypted multiplex.

6. A method in accordance with claim 5, wherein said step of resolving conflicts in protocol data comprises re-mapping program identifiers.

7. A method in accordance with claim 5, wherein said step of resolving conflicts in protocol data comprises utilizing transport priority bits from the packet headers of said M transport streams to distinguish between the services selected from said M transport streams.

8. A method in accordance with claim 1, wherein said M transport streams are selected from said N transport streams using a cross-point switching device having N inputs and at least M outputs.

9. A method in accordance with claim 1, wherein:
said N encrypted multiplexed transport streams are provided by a tuning device; and
said tuning device comprises at least one in-band tuner, at least one out-of-band tuner, at least one DOCSIS tuner, at least one analog encoder, at least one IEEE-1394 network interface, and at least one playback channel from a storage device.

10. A method in accordance with claim 1, wherein:
N equals eight; and
M equals two.

11. A method in accordance with claim 10, wherein:
said eight encrypted multiplexed transport streams are provided by a tuning device; and
said tuning device comprises a first in-band tuner, a second in-band tuner, a DOCSIS tuner, an out-of-band tuner, a first analog encoder, a second analog encoder, an IEEE-1394 network interface, and a playback channel from a storage device.

12. A method in accordance with claim 1, wherein:
one of said M transport streams is provided by a playback channel from a storage device.

13. A method in accordance with claim 12, further comprising:
encrypting MPEG encoded analog transport streams; and
storing said encrypted MPEG encoded analog streams on said storage device.

14. A method in accordance with claim 13, wherein access to said services on said storage device is provided on an on-demand basis for a fee.

15. A method in accordance with claim 1, wherein said selection of said desired services is enabled via a host processor.

16. A method in accordance with claim 1, further comprising:
decoding the decrypted services.

17. A method in accordance with claim 1, wherein said services comprise television services.

18. Apparatus for simultaneously decrypting multiple services received on separate encrypted multiplexed transport streams, comprising:
a tuning device for receiving N encrypted multiplexed transport streams, each transport stream having at least one service;
a host processor for selecting a plurality of desired services from M of said N transport streams;
a multiplexer for multiplexing said desired services into a desired service multiplex;
a decryption device for decrypting the desired service multiplex to obtain a desired decrypted multiplex; and
a first demultiplexer for demultiplexing said desired decrypted multiplex.

19. Apparatus in accordance with claim 18, further comprising at least one of:
a second demultiplexer for demultiplexing said M transport streams,
a filter for filtering said M transport streams.

20. Apparatus in accordance with claim 18, wherein at least one of said M transport streams comprises an MPEG stream.

21. Apparatus in accordance with claim 18, wherein:
each of said M transport streams comprises one of an MPEG stream or an Internet Protocol based stream.

22. Apparatus in accordance with claim 18, wherein:
conflicts in protocol data among the selected services in the desired service multiplex are resolved at said multiplexer; and
original protocol data is restored to the selected services at said demultiplexer when demultiplexing the desired decrypted multiplex.

23. Apparatus in accordance with claim 22, wherein said conflicts in protocol data are resolved by re-mapping program identifiers.

24. Apparatus in accordance with claim 22, wherein conflicts in protocol data are resolved by utilizing transport priority bits from the packet headers of said M transport streams to distinguish between the services selected from said M transport streams.

25. Apparatus in accordance with claim 18, further comprising a cross-point switching device for selecting said M transport streams from said N transport streams, wherein said cross-point switching device has N inputs and at least M outputs.

26. Apparatus in accordance with claim 18, wherein:
said tuning device comprises at least one in-band tuner, at least one out-of-band tuner, at least one DOCSIS tuner, at least one analog encoder, at least one IEEE-1394 network interface, and at least one playback channel from a storage device.

27. Apparatus in accordance with claim 18, wherein:
N equals eight; and
M equals two.

28. Apparatus in accordance with claim 27, wherein:
said tuning device comprises a first in-band tuner, a second in-band tuner, a DOCSIS tuner, an out-of-band tuner, a first analog encoder, a second analog encoder, an IEEE-1394 network interface, and a playback channel from a storage device.

29. Apparatus in accordance with claim 18, further comprising:
a storage device for providing one of said M transport streams via a playback channel.

30. Apparatus in accordance with claim 29, wherein:
MPEG encoded analog transport streams are encrypted at said decryption device; and
said encrypted MPEG encoded analog streams are stored on said storage device.

31. Apparatus in accordance with claim 30, wherein access to said services on said storage device is provided on an on-demand basis for a fee.

32. Apparatus in accordance with claim 18, further comprising:
a decoder for decoding the decrypted services.

33. Apparatus in accordance with claim 18, wherein said services comprise television services.
